(19) United States
(12) Patent Application Publication
(10) Pub. No.: US 2020/0332557 A1
(43) Pub. Date: Oct. 22, 2020

(54) TRANSDUCER FOR DIGITAL LOCK

(71) Applicant: ZORE LIFE SHAPING SOLUTIONS LTD., Jerusalem (IL)

(72) Inventors: Yalon FISHBEIN, Jerusalem (IL); Guni KOFMAN, Moshav Ya'ad (IL); Daniel HOROVITZ, Kfar Tavor (IL)

(21) Appl. No.: 16/920,521

(22) Filed: Jul. 3, 2020

Related U.S. Application Data
(63) Continuation-in-part of application No. PCT/IL2019/050012, filed on Jan. 3, 2019.

(30) Foreign Application Priority Data
Jan. 4, 2018 (IL) 256743
Jan. 11, 2018 (IL) 256884

(51) Int. Cl. E05B 31/00; E05B 47/00; E05B 17/10; E05B 65/48; F41A 17/44; F41A 17/06

(52) U.S. Cl. CPC E05B 31/00; E05B 47/0001; E05B 17/10; G07C 9/00563; F41A 17/44; F41A 17/066; F41A 17/063; E05B 65/48

(57) ABSTRACT

A lock mechanism for engaging a hasp within a housing such that said hasp is lockably engagable within the housing, the mechanism comprising a processor, a power supply such as a battery cell, a memory, a transducer and an actuator, the transducer being operated by a dial such that the processor is designed to analyze the signals from the transducer and to send a signal to the actuator to engage and disengage the hasp when a signal comprising a sequence of forward and backward rotations, each consisting of chains of discrete clicks of the dial corresponds to a stored combination in the memory, and a method of use of same.

### CROSS REFERENCE TO RELATED APPLICATIONS

This application is a continuation-in-part of PCT/IL2019/050012 filed on Jan. 3, 2019 which claims priority to Israel application No. 256743 filed on Jan. 4, 2018 and Israel Application No. 256884 filed Jan. 11, 2018. The contents of these applications are incorporated by reference in their entirety.

### BACKGROUND OF THE INVENTION

A lock is a mechanical or electronic fastening device that is released by a physical object (such as a key, keycard, fingerprint, RFID card, security token, coin etc.), by supplying secret information (such as a key code or password), or by a combination thereof.

Locks are used on doors and safes for holding valuables and directly for securing articles such as handguns, automobiles and bicycles.

Traditional locks are mechanical and are opened with physical keys. These require the physical key to open them. The mechanism usually involves levers, tumblers or pins, and most locks are variations of those designed by Chubb, Yale and Bramah.

Pin tumbler locks are unlocked by rotating a plug. Without a key in the lock, driver pins are pushed downwards, preventing the plug from rotating. In the pin tumbler lock, a set of pins prevents the lock from opening unless the correct key is inserted. The key has a series of grooves on either side of the key's blade that limit the type of lock the key can slide into. As the key slides into the lock, the horizontal grooves on the blade align with the wards in the keyway allowing or denying entry to the cylinder. A series of pointed teeth and notches on the blade, called bittings, then allow pins to move up and down until they are in line with the shear line of the inner and outer cylinder, allowing the cylinder or cam to rotate freely and the lock to open.

A wafer tumbler lock is similar to the pin tumbler lock and works on a similar principle. However, unlike the pin lock (where each pin consists of two or more pieces) each wafer is a single piece. The wafer lock is relatively inexpensive to produce and is often used in automobiles and cabinetry. In wafer tumbler locks, without a key in the lock, the wafers are pushed down by springs. The wafers nestle into a groove in the lower part of the outer cylinder preventing the plug from rotating.

The disc tumbler lock or Abloy lock is composed of slotted rotating detainer discs. They are considered very secure and almost impossible to pick.

The lever tumbler lock uses a set of levers to prevent the bolt from moving in the lock. In its simplest form, lifting the tumbler above a certain height will allow the bolt to slide past.

In tubular locks, the key pins and driver pins are pushed towards the front of the lock, preventing the plug from rotating. The tubular key has several half-cylinder indentations which align with the pins.

Warded locks use a set of obstructions, or wards, to prevent the lock from opening unless the correct key is inserted. The key has notches or slots that correspond to the obstructions in the lock, allowing it to rotate freely inside the lock.

There are also mechanical combination locks, which rely on direct rotation of a dial or a series of disks to release the hasp. To open requires knowledge of the code, i.e. the sequence of numbers or letters that opens the lock.

An electronic lock works by means of an electric current and is usually connected to an access control system. In addition to the pin and tumbler used in standard locks, in electronic locks the bolt or cylinder is moved by an actuator such as a motor within the door or lock housing that is controlled by a processor.

Types of electronic locks include keycard locks which are operated with a flat card having the size and shape of a credit card. In order to open the door, one needs to successfully match the code within the keycard to that of the lock. These are widely used in hotels, for example.

Smart locks are electromechanical locks that receive instructions to lock and unlock from an authorized device using a cryptographic key and wireless protocol or a biometric identification sensor. Smart locks have begun to be used more commonly in residential areas, and are often controlled with smart phones. Smart locks are widely used in shared workspaces and offices to enable keyless office entry. Biometric identification is user specific. To authorize additional users to open a lock with a biometric identifier, requires reprogramming the lock to accept the additional users. Thus unlike codes or keys which can be given by authorized personnel to someone, biometric identification cannot. This has advantages and disadvantages.

The sidebar lock operates using fins on a radial key that actuate sidebars that align with a cylindrical code bar within the lock. This type of master key technology has been developed by the Australian Lock Company. The keys and the code bar are cut using a computer numerical control (CNC) machine.

As a metaphor, data is secured using encryption which is encrypted and decrypted using one or more strings of data that are often referred to as keys.

Despite the wide range of locks and keys available, there is a need for a transducer and mechanism for a quick release lock that does not require a physical key, whether mechanical or electronic, and which can be operated reliably in the dark and in any environmental condition and do not have the disadvantages of biometrics based identification systems. The present invention provides such a lock.

### SUMMARY OF THE INVENTION

This application incorporates by reference the subject matter of PCT/IL2019/050012 filed on Jan. 3, 2019, Israel application No. 256743 filed on Jan. 4, 2018 and Israel Application No. 256884 filed Jan. 11, 2018. The contents of these applications are incorporated by reference in their entirety.

The term hasp is used herein to include hasps of padlocks, bolts of door locks and any other mechanical locking element that physically prevents engages a housing or similar.

A first aspect of the invention is directed to a lock mechanism for engaging a hasp within a housing such that said hasp is lockably engagable within said housing, the mechanism comprising a processor, a power supply, a memory, a transducer and an actuator, the transducer having a stator and rotator, such that the rotator is fixedly coupled by a stem to a dial for rotating the rotator with respect to the stator; the transducer comprising a flange having conductive and insulating areas on an inner face, and an array of pins coaxially aligned with the flange such that rotation of the dial causes relative motion between the flange and the array of contact pins about the axis, thereby selectively contacting the contacting pins with the insulating and conductive areas on the inner face, for data entry; the said face of the flange comprising a first ring that is conductive, at least one partially conductive second ring having conductive areas that are connected to the first circle and insulating areas that are non-conductive, and a third ring with contact positions at regular intervals having radial symmetry with each other, that are separated by insulating positions; the flange is kept in compressive contact with the array of contact pins which include a ground contact pin, an array of contact pins arranged asymmetrically around at least one second circle for providing 2ⁿ alternatives for a digit in a combination of digits, and a third circle with a first contact pin that alternatively connects to conducting and insulating areas of the third ring of the flange as it is rotated, and a clicking mechanism that ensures that a dial that is not physically restrained from turning will slip into a position where the first contact-pin in the third circle contacts an insulating area, providing no signal to the processor and drawing no power from the power supply;

such that said processor is configured for receiving signals from said transducer as it is rotated, analyzing said signals and sending an instruction to the actuator to engage or disengage the hasp when an appropriate signal comprising a combination of forward and backward rotations, each corresponding to chains of discrete clicks of the dial corresponds to a stored combination in the memory.

Typically the power supply is a dry battery cell.

Optionally, the click mechanism comprises a radially symmetrical ring of ball bearings providing a pivot, the ring of ball bearings being pressed by a Hookian element such as one or more helical springs against the distal surface of the flange having an array of concave sockets, each having a radius of curvature at least equal to that of the ball bearings, such that the radially symmetrical ring of ball bearings entering and leaving sockets of the array provides a user with a tactile clicking sensation as the dial is rotated, and, on release of the dial by a user, the Hookian element urges the ring of ball bearings to rotate into the array of sockets, thereby rotating the flange to assume a position where the first contact-pin contacts the insulating area.

In some embodiments, n is 3 providing 2³ which is 8 separate signals that are encoded in binary as [000 001 010 011 100 101 110 111] and the pin positions and the combination of digits for actuating the actuator is in a base between 4 and 8 depending on the number of dial positions in a revolution and a associated level of redundancy.

Optionally, the lock mechanism further comprises a second, shorter pin opposite the third ring, that is at an angle to the first contact-pin in the third ring such that it is opposite a conducting region of the third ring when the rotatable transducer is in a released rest position, but does not contact the third ring, by virtue of it being shortened; such that pushing on the dial causes the flange to contact the said second shorter pin and to send a signal to the processor.

Preferably, the lock mechanism further comprises at least one lamp coupled to the processor, the second shorter pin and the power supply such that pressure for a first time interval on the dial causes the at least one light lamp to emit a signal indicative of level of power available from the power supply.

In some embodiments, in addition to a preprogrammed unlocking combination, a user may program at least one or more additional combination.

In some embodiments, the lock mechanism further comprises a reset function comprising pressing the rotatable switch inwards.

Optionally, pressure on the dial for a second time interval causes the second shorter pin facing the third ring to contact the flange and to send a signal to the processor that a new combination is to be inserted; said new combination being insertable by rotation of the dial back and forth a number of times and by numbers of clicks determined by the user, followed by a further pressing on the dial to enter the new combination into the memory.

In some embodiments, the lock mechanism is configured to require the new combination to be immediately reentered to provide a confirmation and the confirmation is indicated by a lamp being illuminated.

Optionally, the lock mechanism further comprises at least one alternative signal input means for inputting an alternative signal, the alternative signal means being coupled to the processor selected from the group comprising a signal receiver for receiving remote signals for unlocking the lock by transmission of the sequence, a biometric identifier of a user from an appropriate reader and a token.

Optionally, the alternative signal input means comprises a signal receiver for receiving remote signals that are transmittable from a mobile phone.

Optionally, the at least one alternative signal input means comprises a token that communicates via Bluetooth transceiver or RFID reader.

Optionally, the at least one alternative signal input means comprises a token that further comprises a keypad.

In some embodiments, whilst signals are being received at the processor from both the transducer and from at least one alternative signal means the signals from the transducer takes precedent.

Typically, the actuator is selected from the group comprising dc linear motors, stepper motors and electromagnets.

In some embodiments, the sequence of digits entered by rotation of the rotatable dial is compared with a sequence in a look up table.

A second aspect of the invention is directed to a method of entering a combination to a lock mechanism for engaging a hasp within a housing such that said hasp is lockably engageable within said housing;

the mechanism comprising a processor, a power supply, a memory, a transducer and an actuator, the transducer comprising a rotator and a stator having a common axis; the rotator being coupled to a dial by a fixed axle stem, one of said rotator and stator comprising an array of pins arranged in three rings, and the other of said rotator and stator comprising a flange having a face opposite said array of pins that is divided into conductive areas and insulating areas, the face of the flange being in physical contact with contact pins of the array of pins for data entry; said face comprising a first ring that is conductive, at least one second ring comprising conductive areas that are connected to the first ring and insulating areas that are non-conductive, and a third ring with contact positions at regular intervals having radial symmetry separated by insulating positions; the said face being in compressive contact with the array of contact-pins; the array of contact pins comprising a ground pin, an array of n contact-pins in said at least one circle for providing 2ⁿ alternatives for a digit in a combination of digits, and a first contact pin facing the third ring that alternatively connects to conducting and insulating areas of the third ring of the flange as it is rotated, and a clicking mechanism that ensures that a dial not physically restrained from turning will slip into a position where said first contact-pin contacts an insulating area, providing no signal to the processor and drawing no power from the power supply; such that said processor is configured to send a signal to the actuator for engaging or disengaging the hasp when a signal comprising a sequence of forward and backward clicks of the dial corresponds to a sequence in the memory;

the sequence being enterable via the dial of the electronic lock system by firstly rotating the dial in a first direction by a first number of clicks to enter a first digit; then rotating the dial in a counter direction for a second number of clicks to enter a second digit; and by reversing directions and turning for a preset number of clicks to enter each subsequent digit of the sequence until the entire combination is inserted, such that rotating the dial by less than a first click of the first digit in the sequence causes a signal from the first contact pin facing the third ring to activate the processor.

Typically, reading the signals from the second ring upon initiating the movement of the dial and conducting an additional reading of the second ring signals upon reaching the following dial station, allows the processor to determine the direction of the move of each and every single click of the dial turn. Preferably, a first digit inputted from the rotating transducer by the user rotating the dial is received by the processor and is compared with a first digit of the correct combination code stored in the memory; such that if there is no match, the data input has to be started from the beginning, and if there is a match, a next digit of the data is inputted by rotating the dial a number of clicks in an opposite direction, the number inputted being compared by the processor with a next digit of the correct combination code stored in the memory, such that if there is no match, the data input has to be started from the beginning, and if there is a match, the user has to input the second next digit of the sequence, and if the inputted digit is matched with the final digit of the combination, a signal is sent by the processor to the actuator to engage or disengage the hasp.

Typically, the initial direction of rotation of the dial is irrelevant.

Preferably, as long as the final digit of the input combination equals or exceeds the final digit of the combination in the memory, the actuator is enabled.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic block diagram of an electronic lock system 10 in accordance with an embodiment of the invention;

FIG. 2 is a flow chart of a method for inputting data via the dial 11 of the electronic lock system 10 of FIG. 1;

FIG. 3 is a flow chart of the algorithm for actuating the lock mechanism 10 of FIG. 1 using the transducer 12;

FIG. 4 is an isometric projection of a first part 12A of the transducer 12;

FIG. 5 is a schematic exploded illustration of the transducer 12 for the lock mechanism of FIG. 1.

### DESCRIPTION OF EMBODIMENTS

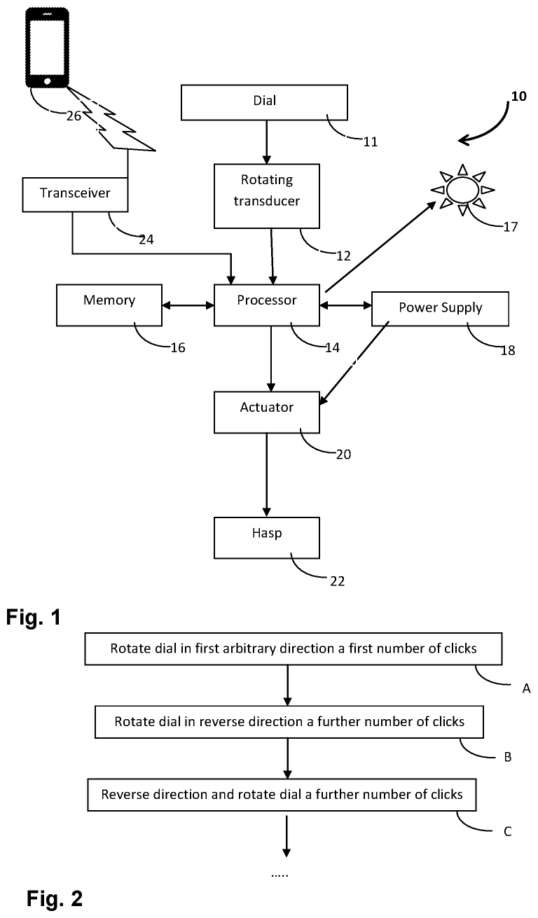

With reference to FIG. 1, the electronic lock system 10 of the invention essentially comprises a dial 11 fixedly coupled to the axle of a rotator of a transducer 12 comprising a rotator and a stator that are coaxially aligned and held together by a Hookian element such as a spring, for example a coiled spring or range of springs that is in data communication with a processor 14 that is in data communication with a memory 16 and is coupled to a power supply 18, such as a dry cell battery, for supplying electrical power. Both the power supply 18 and the processor 14 are coupled to an actuator 20. Optionally a transceiver 24 is also provided for receiving an electronic key transmitted from a mobile phone 26 or the like. One or more lamps 17, typically light emitting diodes (LEDs), are provided. LEDS are ideal as they draw minimum power and are readily and cheaply available in different colors, particularly green-yellow and red.

The rotating transducer 12 provides a series of signals that are compared by the processor chip 14 to a code stored in the memory 16. If the correct code sequence is input, the processor chip 14 sends a signal to the actuator 20 which interacts with the hasp 22 and enables it to lock and unlock.

FIG. 2 is a flow chart of a method for inputting data via the dial 11 of the electronic lock system 10 of FIG. 1. Firstly the dial 11 is rotated either clockwise or counterclockwise by a first number of clicks to enter a first digit—step A. Then the direction of rotation is reversed for a second number of clicks to enter a second digit—step B. The direction of rotation is then reversed a second time, to enter a third digit—step C, and so on, until all the digits of the combination sequence are entered.

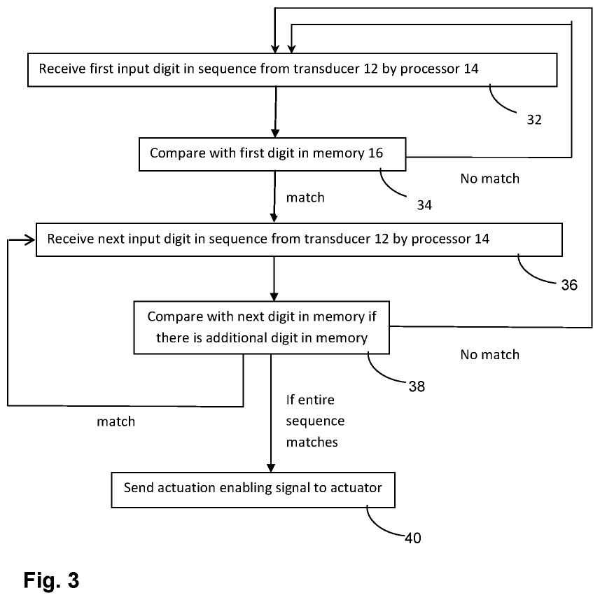

FIG. 3 is a flow chart of the algorithm for actuating the lock mechanism of FIG. 1 using the rotatable transducer 12, and describes the activities from the perspective of the processor 14.

A first digit inputted from the transducer 12 by the user rotating the dial 11 is received by the processor 14—step 32. This is compared by the processor 14 with a first digit of the correct combination code stored in the memory 16—step 34.

If there is no match, the user has to send the correct sequence again from the beginning by repeating step 32. If, however, there is a match, the user has to input the next digit of the sequence—step 36. This is compared by the processor 14 with a next digit of the correct combination code stored in the memory 16—step 38.

If there is no match, the user has to send the correct sequence again from the beginning by repeating step 32. If there is a match, the user has to input the next digit of the sequence—step 36 again. If, however, the digit to be matched is the final digit of the combination and the number of clicks matches or exceeds the final digit of the combination in the memory, a signal is sent by the processor 14 to the actuator 20 to actuate the lock to engage or disengage the hasp 22.

The actuator 20 is typically a stepper motor. However, it could be a linear motor or even an electromagnet that simply attracts and withdraws the hasp engaging part of the lock or withdraws the bolt, etc to lock and or unlock the lock.

The electronic sequence provided by the transducer 12 is relatively short. In preferred embodiments, the user may set a combination via the dial 11.

To prevent the lock opening by random fiddling, preferably the combination comprises a sequence of at least 5 digits.

Referring back to FIG. 1, in some embodiments, in addition to being able to enter sequences via the dial 11 a series of signals may be entered by one or more additional means. Optionally, a transceiver 24 is provided that can receive a combination sequence from a remote transmitter 26 such as a mobile phone, for example. In such cases, the signal to be received from the remote transmitter 26 should be much longer to prevent brute force attacks. Alternatively, a dial up code or protocol handshake may be used in combination to the sequence of digits to unlock the lock mechanism 10. To prevent simple brute force unlocking via the transceiver 24, using a mobile phone, or the like, a dial code is first required. The combination of dial up code and electronic key provide a longer and thus safer electronic code that cannot be easily cracked by mere brute force.

Additionally or alternatively, a token may be read by an appropriate receiver 24. This can usefully be achieved remotely using an RFID reader or Bluetooth protocol transceiver, but a wired receiver for receiving a swipe card or similar, is also possible. Additionally or alternatively, a biometric reader, such as a finger print, or facial recognition, or voice recognition or iris identifying reader may be used.

It is a particular feature of preferred embodiments that numbers may be inputted solely by rotating the dial 11. The user senses a series of tactile clicks as the dial 11 is rotated, and the number of clicks in either direction before a change of direction corresponds to a digit inputted. A change in direction signifies the end of a digit being input and a new number being inputted. The first selected direction of rotation is not important.

A feature of a preferred embodiment of the lock mechanism 10 is that it draws no power when not in use, and that the first click is registered as part of the first digit and not merely as an awakening signal.

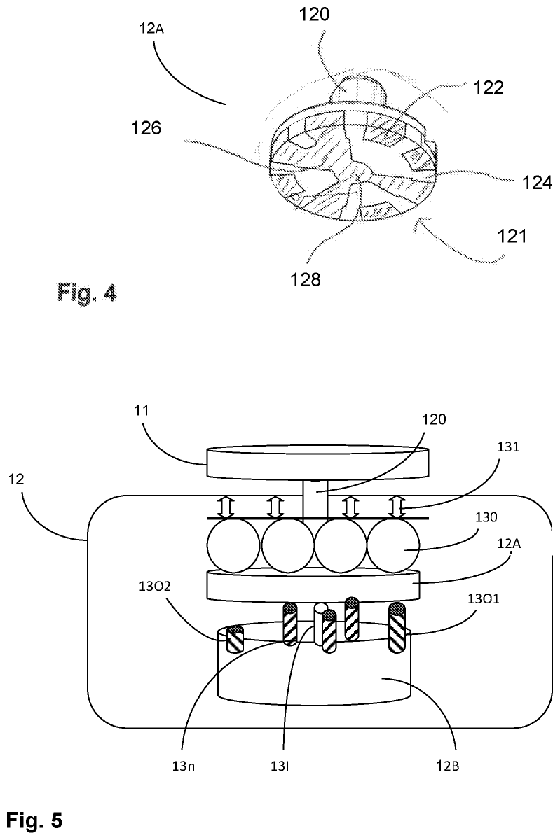

With reference to FIG. 4, a schematic illustration of a first part 12A of a transducer 12 according to one embodiment is shown. The first part comprises a flange 121 coupled to or having a stem 120 on a distal side. The proximal face of the flange 121 is divided into conductive areas 122, 126, 128 and into an insulating areas 124.

The proximal face of the flange 121 has an outer ring consisting of a radially symmetrical conductive areas 122 separated by insulating areas 124. In the embodiment shown, there are eight conducting areas in the outer ring separated by eight interconnected insulating area 124. Thus each conducting area in the outer ring is typically a 22.5° segment of the perimeter ring separated by 22.5° insulating segments. Each conductive area 122 of the outer ring is typically same length as each other conductive area of the outer ring, and the conductive areas are radially arranged, but the conductive and insulating areas of the outer ring need not necessarily subtend the same angle, for example, the conductive sections could each subtend 25° and be separated by insulating sections that subtend 20° for example.

The inner circle 128 of the flange 121 is also conductive. One of more intermediate circles 126 may be patterned to include both conductive and non-conductive elements.

Referring now to FIG. 5, the second part 12B of the transducer 12 consists of an array of contact pins 13. The contact pins of the embodiment shown are spring pins. The spring pin or pogo pin is a standard device used in electronics to establish a (usually temporary) connection between two printed circuit boards.

The array of contact pins includes a first outer spring pin 13O1, an inner spring pin 13I, and an array of n intermediate spring pins 13n. Preferably a second short outer spring pin 13O2 is also provided that in general does not contact the flange, and so is referred to as a short pin.

Referring to FIG. 5, a schematic illustration of the rotatable transducer 12 is shown. The rotatable transducer consists of the first part 12A and a second part 12B which includes an array of spring pins 13, sometimes known as pogo pins.

The first part 12A is pressed against the second part by a Hookian element 131 that is typically some type of spring, such as a leaf spring, one or more helical springs, etc.

A pivot consisting of a radially symmetrical ring of ball bearings 130 is also provided between the distal part of the flange 121 of the first part 12A and the casing.

The distal face of the flange 121 of the first part 12A is provided with a radially symmetrical ring of sockets that each has a radius of curvature at least equal to that of the ball bearings 130 and which are arranged such that due to their geometry and the pressure of the Hookian element(s) 131, release of the dial 11 results in the ball bearings being forced into sockets, and this aligns an insulating part 124 of the third ring on the face of the flange 121 with the first contact pin 13O1.

Rotation of the dial 11 causes the flange 121 with respect to the pin array 12B. The alternating insulating area 124 and conducting areas 122 result in contact being made and broken between the conducting areas 122 in the third ring and the first spring pin 13O1 as the ball bearings 130 click in and out of the sockets as the first part 12A of the transducer 12 is rotated by turning the dial 11. This results in a countable signal that is detected in a tactile manner by the user turning the dial 11.

The inner circle 128 may be configured to always be in contact with a central spring pin 13I providing a ground.

Where there are n pins arranged asymmetrically around the intermediate ring which interact with the intermediate conductive areas 126 on the face of the flange 121, there are 2ⁿ possibilities providing 2ⁿ distinctive signals. For example, if there are 3 intermediate spring pins 13n, and the dial can assume any of 8 distinct positions it can code 0 to 7 different possibilities for a dialed in digit.

In this manner, 3 intermediate pins 13n allows combinations in base 8, or more generally, n pins allows combinations in base 2n or in any other base between base 2ⁿ⁻¹ and 2ⁿ if 1 the number of discrete dial positions available is less than 2ⁿ.

The eight positions may be equivalent to the digits 0 to 7 as shown in the following look up table:

| Digit | Pin 3 | Pin 2 | Pin 1 |
|---|---|---|---|
| 0 | 0 | 0 | 0 |
| 1 | 0 | 0 | 1 |
| 2 | 0 | 1 | 0 |
| 3 | 0 | 1 | 1 |
| 4 | 1 | 0 | 0 |
| 5 | 1 | 0 | 1 |
| 6 | 1 | 1 | 0 |
| 7 | 1 | 1 | 1 |

As shown in FIGS. 4 and 5, the rotator of the transducer 12 is the first part 12A with the flange being coaxial to the pin array 12B which is the stator. However, it will be appreciated that the same signaling could be obtained with a pin array fixedly connected with a dial that is rotated with respect to a disc that is the stator.

Similarly, as drawn, the first ring is the inner circle which is conductive, the second ring is an intermediate circle which is used for signaling the number of clicks, and the third ring is the outer circle on the flange 121 which is used for ensuring that no power is drawn when the dial is in a rest position and the first pin 13O1 which is an outer pin, is aligned with an insulating region of the outer ring. The first pin 13O1 and the other pins 13 of the second part 12B are appropriately aligned with each of these circles. This arrangement is convenient, but the ring used for indicating clicks, that used for grounding purposes and that used for signaling that a rotation is being initiated and the direction of rotation could be switched around in other configurations and embodiments.

In the embodiment shown, there are n pins 13n in the second, or intermediate ring, and this provides 2ⁿ possible signals enabling coding in base 8. It will be appreciated, however, that if the ball bearing arrangement 130 consists of say 7 ball bearings that can rest in seven sockets, the dial would be only able to assume 7 positions and one of these signals would be redundant and the signaling would be in base 7.

Different embodiments could thus have n pins for signaling up to 2ⁿ options for each digit, for coding in any base between 2ⁿ and 2ⁿ. This, combined with the possibility of rotating the pin array with respect to the flange instead of the flange with respect to the pin array, and of using, say, the second ring for initiating the combination and activating the battery and the third (outer) ring for counting, provides a range of embodiments that conceptually similar and are within the scope of the invention, such that the specific embodiment of FIGS. 4 and 5 is by way of non-limiting example only.

Furthermore, the same basic principle could be achieved by having a range of LEDs on the rotator interacting with a range of light detectors on the stator, or a range of light detectors on the rotator interacting with a range of LEDS on the stator. Indeed, a single LED could be placed behind a rotator or stator that is perforated to allow light signals to fall on a light detector such as a LDR (light detecting resistor). Since the principle will now be well understood by persons of the art, no further details of these embodiments are provided. The embodiment that is detailed in depth if provided for the purpose of enablement whereas the scope of protection is provided by the claims.

If the memory 16 is not user settable it may be a Read Only Memory ROM. Otherwise, it is typically a Random Access Memory or RAM, and may be a flash memory, for example.

Preferably, the memory 16 is user settable and the combination of the lock mechanism 10 is programmable. For example, a short second outer pin 13O2 may be provided set at an angle to the first outer pin 13O1 such that at a rest position where the first outer pin 13O1 is opposite an insulating area 124, the second short outer pin 13O2 is opposite a conductive area 122. The short second outer pin 13O2 may be used for one or more purposes.

If the dial 11 is pressed inwards, contact is formed between short second outer pin 13O2 and a conductive area 122 of the flange. This sends a signal to the processor 14, which may be programmed so that a short press tests the battery 18 and sends a signal to illuminates the lamp(s) 17 accordingly. For example, if green and red LEDs are provided, a green signal could indicate that the battery is fine. A red signal or a flashing signal if only one LED is available, could indicate that the battery charge is running low and it should be replaced, for example. If there is insufficient power, the lock could shut down or could automatically unlock, or could indicate a need to change the battery immediately, for example.

Optionally, pressure on the dial 11 for a second time interval, for example, a long press, causes the second short outer spring-pin 13O2 to signal the processor 14 that a new combination is to be inserted, and the new combination is inserted by rotation of the dial 11 back and forth a number of times and by numbers of clicks determined by the user, followed by a further pressing on the dial 11 to enter the new combination into the memory 16.

In some embodiments, the lock mechanism 10 is configured to require the combination to be immediately reentered to provide a confirmation and the confirmation is indicated by a lamp 17 such as a light emitting diode being illuminated.

Optionally, the lock mechanism 10 further comprises at least one alternative signal input means 24 coupled to the processor 14 for inputting an alternative signal. The alternative signal means being selected from the group comprising a signal receiver for receiving remote signals for locking and unlocking the lock by transmission of the sequence such as from a mobile phone for example, a biometric identifier of a user from an appropriate reader or a token, such as an RFID token or magnetic swipe card, for example, that communicates via Bluetooth transceiver or RFID reader for example.

For additional security, the token may contain both a coded key that is transmitted automatically, and a keypad for manual insertion of a code.

Preferably, for security, in some embodiments, whilst signals are being received at the processor from both said at least one alternative signal means and from the rotating transducer, the signals from the rotating transducer take precedent.

The power supply 18 may be a battery such as a CR2 EA lithium cell for example. The EA lithium cell is small, reliable and long lasting for such applications where it is mostly dormant and is occasionally used for signaling, but has the power to operate the actuator 20.

The device described with reference to FIGS. 1 and 4, and the method of inputting data described herein with reference to FIGS. 2 and 3, has the following advantages:
The user may easily operate the dial 11 in the dark, since the number being inputted is detected in a tactile manner by the user who does not need to align visual markings to initiate dialing or during the dialing sequence.
The user does not have to align numbers and the dial 11 does not have to be marked with numbers or other indicators so the user can start dialing a code sequence from any dial angular position.
The user may easily operate the dial 11 with dirty, wet or even oily hands, unlike fingerprint biometrics based locks which requires dry and clean hands for the fingerprint recognition.
Power is only drawn from the power supply 18 when the dial 11 is rotated and this conserves battery power and so a battery such as a CR2 EA lithium cell may last for a very long time.
The user can start rotating in a clockwise or counterclockwise direction. This is invaluable to left handed users who typically try to unscrew nuts and bolts and to open faucets and the like by rotating the wrong way.
The user may start the sequence again at any time.
Because of the data entry method, the electronics is very simple, and a processor 14 with five or six pins is adequate, and the dial 11 and lock mechanism 10 may therefore be relatively compact.
The user does not have to input a dialed number by pressing the dial 11 in or by operating a separate enter button or be reversing the direction of rotation of the dial 11 merely to signify that a digit has been entered.
Since the data is entered by forward and backward rotation of the dial 11 by less than one revolution each time, the dial 11 can be gripped and moved back and forth to enter the entire sequence without letting go.
Unlike systems where the rotation of the dial 11 powers the electronics of the lock mechanism 10 and/or those where after the combination is entered, the user has to activate the hasp 22 or bolt physically, in the present invention, a battery could be used to provide power to the processor 14 and to the actuator 20. This vastly simplifies the electronics and mechanics of the lock mechanism 10. Small batteries 18 such as CR2 lithium cells are readily available and most of the time, no power is drawn. Power is only drawn from the battery during the locking and unlocking process, so a battery may last for a very long time.
In consequence of this method of data entry, a secure multi-digit sequence may be entered via the dial 11 by holding the dial 11 in the fingers and merely rotating the wrist back and forth, simultaneously providing both security and ease and fast unlocking.

The lock mechanism 10 described above can usefully be used for a lock configured for securing a weapon such as a handgun, for example. By handgun any of the following is intended: pistols, revolvers, rifles, shotguns, semi-automatic and fully automatic assault rifles.

Persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A lock mechanism for engaging a hasp within a housing such that said hasp is lockably engagable within said housing, the mechanism comprising:
a processor, a power supply, a memory, a transducer and an actuator;
the transducer having a stator and rotator, such that the rotator is fixedly coupled by a stem to a dial for rotating the rotator with respect to the stator;
the transducer comprising a flange having conductive and insulating areas on an inner face, and an array of contact pins coaxially aligned with the flange such that rotation of the dial causes relative motion between the flange and the array of contact pins about the axis, thereby selectively contacting the contact pins with the insulating and conductive areas on the inner face for data entry;
said face of the flange comprising a first ring that is conductive,
at least one partially conductive second ring having conductive areas that are connected to the first circle and insulating areas that are non-conductive, and a third ring with contact positions at regular intervals having radial symmetry with each other, that are separated by insulating positions;
the face of the flange being kept in compressive contact with the array of contact pins which includes a ground contact pin, an array of contact pins arranged asymmetrically around at least one second circle for providing up to 2ⁿ alternatives for a digit in a combination of digits, and a third circle with a first contact pin that alternatively connects to conducting and insulating areas of the third ring of the flange during relative rotation of the rotator with respect to the stator, and a clicking mechanism that ensures that a dial that is not physically restrained from turning engages a position where the first contact-pin in the third circle contacts an insulating area, providing no signal to the processor and drawing no power from the power supply;
such that said processor is configured for receiving signals from said transducer as it is rotated, for analyzing said signals and for sending an instruction to the actuator to engage or disengage the hasp when an appropriate signal comprising a sequence of forward and backward rotations, each corresponding to chains of discrete clicks of the dial corresponds to a stored combination in the memory.

2. The lock mechanism of claim 1 wherein, the click mechanism comprises a radially symmetrical ring of ball bearings providing a pivot, the ring of ball bearings being pressed by a Hookian element against the distal face of the flange having an array of concave sockets, each having a radius of curvature at least equal to that of the ball bearings, such that the radially symmetrical ring of ball bearings entering and leaving sockets of the array provides a user with a tactile clicking sensation as the dial is rotated, and, on release of the dial by a user, the Hookian element urges the ring of ball bearings to rotate into the array of sockets, thereby rotating the flange to assume a position where the first contact-pin of the third circle contacts the insulating area.

3. The lock mechanism of claim 1, wherein n pins provides up to 2ⁿ signals and the combination for activating the actuator is a combination of digits in a base between 2ⁿ⁻¹ and 2ⁿ.

4. The lock mechanism of claim 3, wherein n is 3 providing up to 8 separate signals that are encoded in binary as [000 001 010 011 100 101 110 111] and the combination for activating the actuator is a combination of digits in any base from base 4 to base 8 depending on level of redundancy.

5. The lock mechanism of claim 1, further comprising a second, shorter pin opposite the third ring, that is at an angle to the first contact-pin in the third ring such that it is opposite a conducting region of the third ring when the rotatable transducer is in a released rest position, but does not contact the third ring, by virtue of it being shortened; such that pushing on the dial causes the flange to contact the said second shorter contact-pin and to send a signal to the processor.

6. The lock mechanism of claim 5, further comprising at least one lamp coupled to the processor, the short outer pin and the power supply such that pressure for a first time interval on the dial causes the at least one light lamp to emit a signal indicative of level of power available from the power supply.

7. The lock mechanism of claim 6, wherein pressure on the dial for a second time interval causes the second shorter pin facing the third ring to contact the flange and to signal to the processor that a new combination is to be inserted; said new combination being insertable by rotation of the dial back and forth a number of times and by numbers of clicks determined by the user, followed by a further pressing on the dial to enter the new combination into the memory.

8. The lock mechanism of claim 7, wherein pressure on the dial for a second time interval causes the second shorter pin facing the third ring to contact the flange and to signal to the processor that a new combination is to be inserted; said new combination being insertable by rotation of the dial back and forth a number of times and by numbers of clicks determined by the user, followed by a further pressing on the dial to enter the new combination into the memory.

9. The lock mechanism of claim 8 wherein the lock mechanism is configured to require the combination to be immediately reentered to provide a confirmation and the confirmation is indicated by a lamp being illuminated.

10. The lock mechanism of claim 1, further comprising at least one alternative signal input means for inputting an alternative signal, the alternative signal means being coupled to the processor selected from the group comprising a signal receiver for receiving remote signals for unlocking the lock by transmission of the sequence, a biometric identifier of a user from an appropriate reader and a token.

11. A method of entering a combination to a lock mechanism for engaging a hasp within a housing such that said hasp is lockably engageable within said housing; the mechanism comprising a processor, a power supply, a memory, a transducer and an actuator, the transducer comprising a rotator and a stator having a common axis; the rotator being coupled to a dial by a fixed axle stem, one of said rotator and stator comprising an array of pins arranged in three rings, and the other of said rotator and stator comprising a flange having a face opposite said array of pins that is divided into conductive areas and insulating areas, the face of the flange being in physical contact with pins of the array for data entry;
the face comprising a first ring that is conductive, at least one second ring comprising conductive areas that are connected to the first ring and insulating areas that are non-conductive, and a third ring with contact positions at regular intervals having radial symmetry separated by insulating positions;
said face being in compressive contact with the array of contact-pins;
the array of contact pins comprising a ground pin, an array of n contact-pins in said at least one circle for providing up to 2ⁿ alternatives for a digit in a combination of digits, and a first contact pin facing the third ring that alternatively connects to conducting and insulating areas of the third ring of the flange as it is rotated, and a clicking mechanism for ensuring that a dial not physically restrained from turning will assume a position where said first contact-pin contacts an insulating area, providing no signal to the processor and drawing no power from the power supply; such that said processor is configured for receiving signals from said transducer as it is rotated, for analyzing said signals and for sending an instruction to the actuator for engaging or disengaging the hasp when a signal comprising a sequence of forward and backward clicks of the dial corresponds to a stored combination in the memory;
the sequence being enterable via the dial of the electronic lock system by first rotating the dial in a first direction by a first number of clicks to enter a first digit; then rotating the dial in a counter direction for a second number of clicks to enter a second digit; and
by reversing directions and turning for a preset number of clicks, entering each subsequent digit of the combination until the entire combination is inserted, such that rotating the dial by less than a first click of the first digit in the sequence causes a signal from the first contact pin facing the third ring to activate the processor.

12. The method of claim 11 wherein a first digit inputted from the rotating transducer by the user rotating the dial is received by the processor and is compared with a first digit of the correct combination code stored in the memory; such that if there is no match, the data input has to be started from the beginning, and if there is a match, a next digit of the data is inputted by rotating the dial a number of clicks in an opposite direction, the number inputted being compared by the processor with a next digit of the correct combination code stored in the memory, such that if there is no match, the data input has to be started from the beginning, and if there is a match, the user has to input the second next digit of the sequence, and if the inputted digit is matched with the final digit of the combination, a signal is sent by the processor to the actuator to engage or disengage the hasp.

13. The method of claim 11 wherein reading the signals from the second ring upon initiating the movement of the dial and conducting an additional reading of the second ring signals upon reaching a following position allows the processor to determine the direction of the move of each and every single click of the dial turn.

14. The method of claim 11 wherein as long as the final digit of the input sequence equals or exceeds the final digit of the combination in the memory, the actuator is enabled.

15. A locking device for a firearm having a firing chamber, comprising:
a cartridge-mimicking member configured to be inserted into the firing chamber and having a cartridge wall with an outer surface, a distal portion, a proximal portion, and a longitudinal axis extending between said proximal portion and said distal portion;
a tightening mechanism comprising: at least one resilient member integrated in said cartridge wall; and one or more rigid segments integrated in said resilient member, each of said segments having an outermost segment face, said tightening mechanism being configured for outwardly expanding said resilient member from a non-expanded state to at least one expanded state in which said outermost segment faces protrude with respect to said outer surface to an extent greater than at said non-expanded state.

16. The locking device of claim 15, wherein, at said non-expanded state, each of said outermost segment faces protrudes with respect to said outer surface.

17. The locking device of claim 15, wherein, at least at said non-expanded state, one or more of said segments is surrounded by respective portions of the resilient member and/or at least said one resilient member is surrounded by respective portions of the cartridge wall.

18. The locking device of claim 15, wherein said proximal portion comprises an extraction rim being configured to engage an extractor of said firearm so as to allow pulling the cartridge-mimicking member at an extracting direction extending from said distal portion to said proximal portion and along said longitudinal axis; and wherein said locking device further comprises: a locking mechanism switchable between an unlocked state in which said resilient member is at said non-expanded state so that pulling said extraction rim in the extracting direction allows extraction of said cartridge-mimicking member from the firing chamber, and a locked state in which pulling said extraction rim at the extracting direction relative to said rigid segments entails expansion of said resilient member by said tightening mechanism to at least said one expanded state; and a controller in communication with the locking mechanism for switching the state of the locking mechanism at least from said locked state and said unlocked state.

19. The locking device of claim 18, wherein said tightening mechanism further comprises: a movable member connected to said proximal portion and configured for displacing along said longitudinal axis together with said proximal portion and comprising one or more first channels, each of said segments further has an inner segment face with a second channel facing its respective first channel; and one or more rigid rolling members, each disposed between its respective said first channel and said second channel; wherein pulling said extraction rim at the extracting direction entails rolling of each of said rolling members on its first channel toward said distal portion and on its said second channel toward said proximal portion while outwardly radially pressing and displacing said segments, thereby switching said locking mechanism from said non-expanded state to at least said one expanded state.

20. The locking device of claim 19, wherein, at least at said non-expanded state, each of said second channels has a second channel axis extending toward the proximal portion and forming a second acute angle with said longitudinal axis, when viewed from a side of the respective rolling member of the second channel; and wherein, at least at said non-expanded state, each of said second channels has a second channel axis extending toward the proximal portion, so that said second channel axes converge with said longitudinal axis in the direction of said proximal portion; and wherein the first channel axis and its respective second channel axis are substantially parallel to each other.
